(19) United States
(12) Patent Application Publication
(10) Pub. No.: US 2026/0300481 A1
(43) Pub. Date: Oct. 1, 2026

(54) MONITORING DEVICE, MONITORING METHOD, AND RECORDING MEDIUM

(71) Applicant: Panasonic Automotive Systems Co., Ltd., Kanagawa (JP)

(72) Inventor: Nobutaka KAWAGUCHI, Osaka (JP)

(73) Assignee: Panasonic Automotive Systems Co., Ltd., Kanagawa (JP)

(21) Appl. No.: 19/541,968

(22) Filed: Feb. 17, 2026

(30) Foreign Application Priority Data
Mar. 28, 2025 (JP) 2025-055440

(51) Int. Cl. G06F 21/55

(52) U.S. Cl. CPC G06F 21/554; G06F 2221/034

(57) ABSTRACT

A monitoring device (second monitor) is a monitoring device that monitors a monitoring target (application unit) and includes: a first obtainer (process monitor) that obtains a monitoring result of monitoring the monitoring target; a second obtainer (system monitor) that obtains a state of a target system in which the monitoring target is provided; and a determiner (anomaly determiner) that determines, based on the monitoring result obtained and the state obtained, the cause of an anomaly that occurred in the monitoring target, and outputs a determination result indicating whether the anomaly is caused by an attack.

### CROSS REFERENCE TO RELATED APPLICATION

The present application is based on and claims priority of Japanese Patent Application No. 2025-055440 filed on March 28, 2025.

### FIELD

The present disclosure relates to a monitoring device, a monitoring method, and a recording medium.

### BACKGROUND ART

Conventionally, a plurality of electronic control devices that are interconnected via an in-vehicle network are provided in an automobile. When some kind of anomaly occurs in these electronic control devices, there is a demand for identifying the cause of the anomaly by collecting and analyzing various logs pertaining to the operation of the electronic control device. Patent Literature (PTL 1) discloses an electronic control device which, when an anomaly occurs in the electronic control device, is able to reliably collect, in a high security region, a log pertaining to the anomaly, by using virtualization technology.

### CITATION LIST

### Patent Literature

PTL 1: Japanese Unexamined Patent Application Publication No. 2020-129238

### SUMMARY

However, the analyzing a log pertaining to an anomaly can be improved upon. In view of this, the present disclosure provides a monitoring device, and so on, that is capable of improving upon the related art.

A monitoring device according to an aspect of the present disclosure is a monitoring device that monitors a monitoring target. The monitoring device includes: a first obtainer that obtains a monitoring result of monitoring the monitoring target; a second obtainer that obtains a state of a target system in which the monitoring target is provided; and a determiner that determines, based on the monitoring result obtained and the state obtained, a cause of an anomaly that occurred in the monitoring target, and outputs a determination result indicating whether the anomaly is caused by an attack.

A monitoring method according to an aspect of the present disclosure is a monitoring method for monitoring a monitoring target, which is to be executed by a computer. The monitoring method includes: obtaining a monitoring result of monitoring the monitoring target; obtaining a state of a target system in which the monitoring target is provided; and determining, based on the monitoring result obtained and the state obtained, a cause of an anomaly that occurred in the monitoring target, and outputting a determination result indicating whether the anomaly is caused by an attack.

A recording medium according to an aspect of the present disclosure is a non-transitory computer-readable recording device having recorded thereon a program for causing the computer to execute the monitoring method described above.

According to an aspect of the present disclosure, it is possible to improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating the configuration of a monitoring system according to an embodiment.

FIG. 2 is a block diagram illustrating the functional configuration of a second monitor according to the embodiment.

FIG. 3 is a flowchart illustrating the operation of the second monitor according to the embodiment.

FIG. 4 is a flowchart illustrating the operation of a first monitor according to the embodiment.

### DESCRIPTION OF EMBODIMENTS

### Underlying Knowledge Forming Basis of the Present Disclosure

In the analyzing of a log pertaining to an anomaly described in the “Background Art” section, there are instances where transmission of the log to a Security Operations Center (SOC) is necessary, and, conventionally, there are cases where such a log transmission is not performed appropriately. The inventor has found that, as in this example, there are instances where a log cannot be handled appropriately. In view of this, the present disclosure provides, as a monitoring device, a monitoring method, and a recording medium that are capable of improving upon the related art, a monitoring device, a monitoring method, and a recording medium that are capable of generating a log that can be handled more appropriately.

It should be noted that each of the embodiments described below shows a general or specific example. The numerical values, shapes, elements, the arrangement and connection of the elements, steps, the processing order of the steps, etc., indicated in the following embodiments are mere examples, and thus are not intended to limit the present disclosure. Furthermore, among the elements in the following embodiments, structural elements not recited in the independent claims are described as optional elements.

Furthermore, the respective figures are schematic diagrams and are not necessarily precise illustrations. Therefore, for example, the scaling, and so on, depicted in the drawings is not necessarily uniform. Furthermore, in the figures, elements which are substantially the same are given the same reference signs, and overlapping description is omitted or simplified.

Additionally, in the present description, terms indicating relations between elements, such as "match", as well as numerical values and numerical ranges, are not strictly defined and include a substantially same range or a margin of error of a few percent (or about 10 percent).

### Embodiment

Hereinafter, a monitoring system including a monitoring device, and so on, according to the present embodiment will be described.

### 1. Configuration of monitoring system

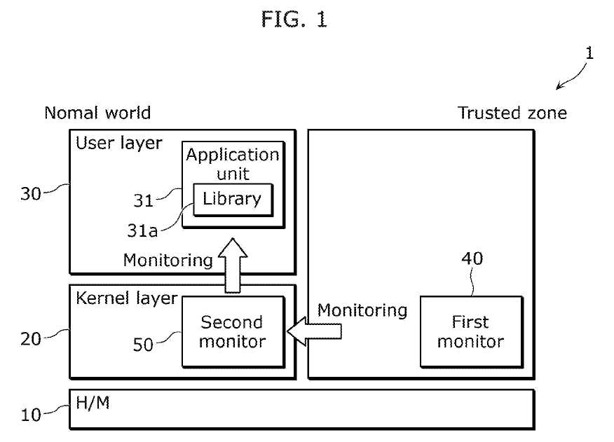

FIG. 1 is a diagram illustrating a configuration of monitoring system 1 according to the present embodiment. Monitoring system 1 is a system for monitoring a monitoring target provided in a vehicle. Monitoring system 1 is realized by, for example, an electronic control unit (ECU), which is a computer provided in the vehicle and includes a processor (microprocessor), a memory, and the like. The memory is, for example, a read only memory (ROM) and a random access memory (RAM). The memory is capable of storing a program to be executed by the processor.

As illustrated in FIG. 1, monitoring system 1 includes hardware 10 (H/W in FIG. 1), and kernel layer 20 and user layer 30 that constitute an operating system (OS) hierarchy. Kernel layer 20 and user layer 30 are provided in a normal world (insecure area), which is different from a trusted zone. The trusted zone is a secure area that limits access from the normal world where an OS and an application operate. Furthermore, in the present embodiment, an example in which software of monitoring system 1 operates on a Linux (registered trademark) (the same applies below) OS will be described. However, this is not limiting.

Hardware 10 is a chip (e.g., system on chip (SoC)) and represents a machine or a device that is capable of receiving data, performing logical operations on data, storing data, and displaying data. However, hardware 10 is not limited to this. Hardware 10 may include a processor and a memory. Furthermore, kernel layer 20 operates on the chip, and user layer 30 operates on kernel layer 20. Kernel layer 20 is also referred to as a kernel space. Furthermore, user layer 30 is also referred to as a user space. User layer 30 is a layer where actions that can be executed are limited compared with kernel layer 20.

Kernel layer 20 includes second monitor 50 as well as a kernel (not illustrated), which is software playing a role of basic functions of the OS. User layer 30 includes an application program and the like for realizing various functions. In the present embodiment, user layer 30 includes application unit 31 including the application program (hereinafter, also referred to as app). It should be noted that the number of application units 31 (i.e., the number of apps) present in user layer 30 is not particularly limited as long as it is greater than or equal to one.

Application unit 31 includes, for example, one or more processes and a memory for the one or more processes. The processes are each an executable unit for a program to be executed by application unit 31. Examples of the app include, but not limited to, an app for realizing WiFi (registered trademark) communication, an app for realizing Bluetooth (registered trademark) communication, an app that controls an image to be displayed to a person who is in the vehicle (e.g., an app for in-vehicle infotainment (IVI)), and an app pertaining to controlling the vehicle (e.g., an app for realizing automated driving function). Functions realized by the apps are set as appropriate in accordance with an object that is provided with monitoring system 1.

Application unit 31 is a monitoring target of second monitor 50. Specifically, the one or more processes included in application unit 31 and the memory are monitoring targets of second monitor 50.

Application unit 31 exists in the normal world, which is not robust from a security perspective, and its process may fail to operate normally due to an attack from the outside or the like. Furthermore, a process of application unit 31 may also fail to operate normally due to a factor that is not security-related.

It should be noted that application unit 31 may be capable of communicating with an integrated ECU provided in the vehicle. The integrated ECU is an ECU that takes a central role for zone ECUs to control the entire vehicle.

Second monitor 50 is a monitoring device that monitors a monitoring target existing in the normal world, such as an app. It can be said that second monitor 50 monitors an app or the like operating in user layer 30. In the present embodiment, second monitor 50 monitors the one or more processes of application unit 31 individually. Second monitor 50 monitors whether the one or more processes of application unit 31 are alive (not ended) and whether the memory in application unit 31 (e.g., memories for the one or more processes) has been tampered with. As such, application unit 31 includes library 31a that either notifies whether a process is alive or holds information for managing a member of a task structure constituting a process. Second monitor 50 monitors whether a process of application unit 31 is alive by obtaining a notification from library 31a or by accessing library 31a.

Furthermore, second monitor 50 monitors the comprehensive state of the system being used by all application units 31, as the system of user layer 30 as a whole, that is, as the target system in which all application units 31 being executed are provided. The state of the system being monitored by second monitor 50 refers to a state of the entire system executing a process, such as, the utilization rate of a processing resource in the target system, the level of execution privilege for the process executed on the target system, the number of processes executed on the target system, the system temperature of the target system, and so on. Although, details will be described later, second monitor 50 determines, based on a monitoring result of monitoring a monitoring target (here, application unit 31) and the state of the target system, whether a notification or information (i.e., the monitoring result) pertaining to an anomaly that occurred in the monitoring target needs to be transmitted to the outside (e.g., the SOC). Here, Linux has such a mechanism that manages any existing process on its own. With the mechanism, Linux determines whether the one or more processes of application unit 31 exist one by one. For example, for every process included in all application units 31 in user layer 30, Linux determines whether the process exists at predetermined time intervals. The process existence may include, for example, the process operating normally.

Although second monitor 50 directly monitors the one or more processes including library 31a, and determines whether the one or more processes are alive based on the result of the monitoring as described above, second monitor 50 may obtain information about the aliveness of each of the one or more processes of each application unit 31, which is determined by the mechanism in Linux, and determine whether the one or more processes of application units 31 are alive based on the obtained information.

Furthermore, second monitor 50 monitors whether a memory of a process has been tampered with.

First monitor 40 is software that runs in the trusted zone, which is a secure area in hardware 10. First monitor 40 monitors second monitor 50 from a robust area in monitoring system 1. Furthermore, first monitor 40 collects, for example, a monitor log of second monitor 50. That is, first monitor 40 collects a log obtained by second monitor 50 monitoring its monitoring targets.

As described above, monitoring system 1 has a configuration in which first monitor 40 operating in the trusted zone being the secure area monitors second monitor 50 arranged in kernel layer 20, and second monitor 50 monitors its monitoring targets operating in the normal world (e.g., the monitoring targets existing in user layer 30). Monitoring system 1 ensures security robustness by forming a chain of monitoring. It should be noted that it is sufficient that monitoring system 1 includes at least second monitor 50, and monitoring system 1 may further include first monitor 40. Alternatively, first monitor 40 may also have the function of second monitor 50 so that, instead, second monitor 50 is not included. As such, the placement of second monitor 50 in monitoring system 1 may be carried out in any manner. In addition, second monitor 50 may be provided in a different kernel layer that is not shown in the figures, and user layer 30 in kernel layer 20 may be monitored via a network, or second monitor 50 may be provided in a different monitoring system, and user layer 30 of monitoring system 1 may be monitored via a network.

It should be noted that first monitor 40 and second monitor 50 are both capable of restarting monitoring system 1. For example, the restart is executed when at least one of first monitor 40 and second monitor 50 is in danger.

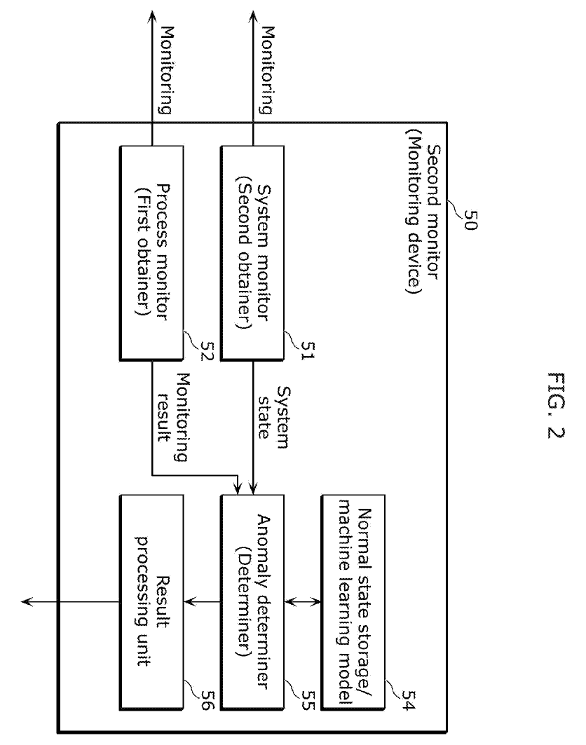

Here, with reference to FIG. 2, a functional configuration of second monitor 50 will be described. FIG. 2 is a block diagram illustrating the functional configuration of second monitor 50 according to the present embodiment.

As illustrated in FIG. 2, second monitor 50 (monitoring device) includes system monitor 51, process monitor 52, normal state storage/machine learning model 54, anomaly determiner 55, and result processing unit 56.

System monitor 51 is an example of a second obtainer, and it monitors the state of the target system in which the process, which is the monitoring target, is being executed (is provided), and obtains, as a result of the monitoring, the state of the target system at that point in time. System monitor 51 outputs the state obtained to anomaly determiner 55. The state which is the result of the monitoring by system monitor 51 is, for example, a CPU utilization rate, a memory utilization, a system temperature of respective parts of the system such as the CPU, and so on. Furthermore, the state which is the result of the monitoring by system monitor 51 includes what the level of execution privilege (user privilege and route privilege, etc.) for executing the process is.

Process monitor 52 is an example of a first obtainer, and monitors whether a process that is a monitoring target is alive (running), whether a memory area used in the process has not been tampered with, and so on, and outputs, as a monitoring result, information indicating the presence or absence of an anomaly. Process monitor 52 outputs the monitoring result to anomaly determiner 55.

Normal state storage/machine learning model 54 holds information for defining a state that is normal for the target system (also referred to as normal state). Normal state storage/machine learning model 54 is either one of a normal state storage or a machine learning model. A normal state storage stores a normal state of the target system for the case where the monitoring target is not under attack. Furthermore, the machine learning model is a trained model that has learned the normal state of the target system for the case where the monitoring target is not under attack. For example, the normal state is computationally calculated under a secure environment in which an attack does not occur, or simulation of a situation in which it is guaranteed that an attack will not occur, or the like.

Anomaly determiner 55 is an example of a determiner, and it determines, based on the monitoring result and the state of the target system, the cause of an anomaly that occurred in the monitoring target and outputs a determination result indicating whether the anomaly is caused by an attack. For example, anomaly determiner 55 first determines, based on the monitoring result, whether an anomaly has occurred in the monitoring target, and, in the determination, when an anomaly is determined to have occurred, further determines whether the anomaly is caused by an attack. In this manner, the determination of whether an anomaly has occurred and the determination of whether the anomaly is caused by an attack are independently determined. For this reason, anomaly determiner 55 is also capable of just determining whether an anomaly is caused by an attack.

Result processing unit 56 performs, based on the determination result of anomaly determiner 55, processing such as transmitting a log to the SOC, another ECU, or the like, or system restarting, and so on. Specifically, the processing that result processing unit 56 performs can be switched depending on when anomaly determiner 55 determines that there is an anomaly, and that the anomaly is caused by an attack, or when it is not (e.g., when the anomaly is caused by a malfunction). In this manner, even in like cases where anomalies occur, since it is possible to switch how the anomaly should be handled from the viewpoint of the system state, it can be said that the log including the state of the system is a log that can be handled more appropriately. Therefore, second monitor 50 (the monitoring device) can generate a log that can be more appropriately handled.

### 2. Operation of monitoring system

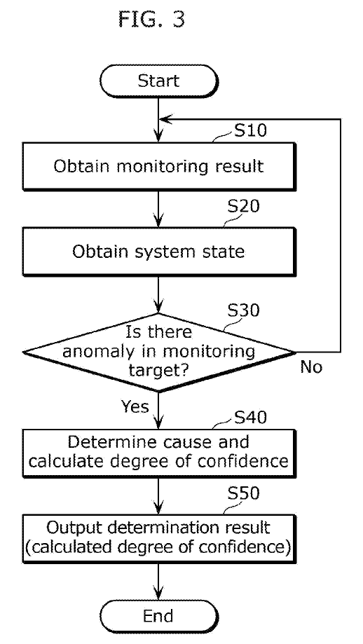

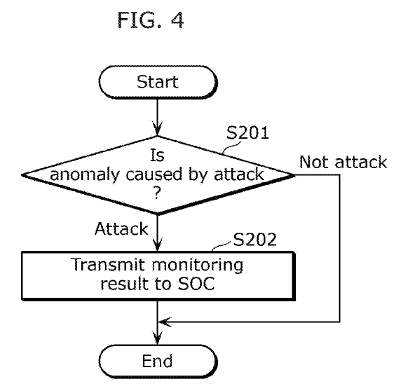

Next, the operation of monitoring system 1 configured in the manner described above will be described with reference to FIG. 3 and FIG. 4. FIG. 3 is a flowchart illustrating the operation (a monitoring method) of second monitor 50 according to the present embodiment.

First, as illustrated in FIG. 3, when the system (monitoring system 1) is activated, process monitor 52 obtains a monitoring result (S10). Since the obtaining of the monitoring result is to be performed continuously from here onward, step S10 can also be referred to as starting the obtaining of the monitoring result.

Next, system monitor 51 obtains the state of the target system (S20). Since the obtaining of the state of the target system is to be performed continuously from here onward, step S20 can also be referred to as starting the obtaining of the state of the target system.

Then, when anomaly determiner 55 determines that there is an anomaly in the monitoring target based on the obtained monitoring result (Yes in S30), the process advances to step S40. When anomaly determiner 55 determines that there is no anomaly in the monitoring target (No in S30), the process returns to step S10.

In step S40, the cause of the anomaly that occurred in the monitoring target is determined. Specifically, anomaly determiner 55 determines, using normal state storage/machine learning model 54, whether the cause of the anomaly is an attack.

When normal state storage/machine learning model 54 is a normal state storage, anomaly determiner 55 determines whether the anomaly is caused by an attack depending on whether the obtained state of the target system is different compared to the stored normal state. Furthermore, when normal state storage/machine learning model 54 is a machine learning model, anomaly determiner 55 inputs the obtained state of the target system to the machine learning model to cause the machine learning model to infer whether the obtained state corresponds to the normal state used in learning, and determines whether the anomaly is caused by an attack based on the result of the inference.

As an example, when a result indicating a memory tampering detection anomaly is obtained as the monitoring result, and, before that, a state of the target system indicating the changing of the process-execution user of the target process was obtained, there is a possibility of a privilege escalation attack, and thus anomaly determiner 55 outputs a determination result (i.e., a log) indicating that the anomaly is suspected to be attack-related.

Furthermore, when a result indicating a memory tampering detection anomaly is obtained as the monitoring result, and, immediately thereafter, a state of the target system indicating the finding of a new process is obtained, there is a possibility of a buffer overflow attack, and thus anomaly determiner 55 outputs a determination result indicating that the anomaly is suspected to be attack-related.

Furthermore, when a result indicating an abnormal termination of process anomaly is obtained as the monitoring result, and, before that, a state of the target system indicating a sudden rise in the CPU utilization rate of the system was obtained, there is a possibility of an attack known as a DoS attack, and thus anomaly determiner 55 outputs a determination result indicating that the anomaly is suspected to be attack-related.

On the other hand, even when a result indicating a memory tampering detection anomaly or an abnormal termination of process anomaly is obtained as the monitoring result, if the state of the target system obtained before that or immediately thereafter corresponds to the normal state, anomaly determiner 55 outputs a determination result indicating that the anomaly is suspected to be malfunction-related.

It should be noted that the determination result outputted by anomaly determiner 55 is indicated by a degree of confidence (level, score, probability, or the like) that the anomaly is caused by an attack. The degree of confidence referred to here is calculated by anomaly determiner 55 based on a degree of deviation, or the like, between the obtained state of the target system and the normal state. For example, when a result indicating an abnormal termination of process anomaly is obtained as the monitoring result, and, before that, a state of the target system indicating a sudden rise in the CPU utilization rate of the system is obtained, anomaly determiner 55 calculates the degree of confidence in such a way that the degree of confidence increases with the length of the period over which the CPU utilization rate rises.

Subsequently, anomaly determiner 55 outputs the determination result (that is, the calculated degree of confidence that the anomaly is caused by an attack) to result processing unit 56.

As illustrated in FIG. 4, result processing unit 56 determines whether the determination result outputted by anomaly determiner 55 indicates that the anomaly that occurred is caused by an attack (S201). For example, when the degree of confidence indicated by the determination result exceeds a predetermined threshold value (50%, or the like), result processing unit 56 treats the determination result as indicating that the anomaly is caused by an attack. Conversely, when the degree of confidence indicated by the determination result is less than the predetermined threshold value (50%, or the like), result processing unit 56 treats the determination result as indicating that the anomaly is not caused by an attack. When result processing unit 56 determines that the anomaly is caused by an attack (“attack” in S201), result processing unit 56 transmits the monitoring result to the SOC (S202). On the other hand, when result processing unit 56 determines that the anomaly is not caused by an attack (“not attack” in S201), result processing unit 56 skips step S202 and ends the process without transmitting the monitoring result to the SOC.

### Advantageous Effects, Etc.

A monitoring device (second monitor 50) according to a first aspect of the present disclosure is a monitoring device that monitors a monitoring target (application unit 31) and includes: a first obtainer (process monitor 52) that obtains a monitoring result of monitoring the monitoring target; a second obtainer (system monitor 51) that obtains a state of a target system in which the monitoring target is provided; and a determiner (anomaly determiner 55) that determines, based on the monitoring result obtained and the state obtained, a cause of an anomaly that occurred in the monitoring target, and outputs a determination result indicating whether the anomaly is caused by an attack.

The monitoring device as described above can determine whether the cause of the anomaly that occurred in the monitoring target is an attack. Specifically, since it is possible to distinguish between an anomaly that is caused by an attack and an anomaly that is not, a generated log pertaining to the anomaly can be classified into a log for handling in the case of an anomaly that is caused by an attack or a log for handling in the case of an anomaly that is not caused by an attack. Therefore, it is possible to generate a log that can be handled more appropriately.

Furthermore, a monitoring device according to a second aspect is the monitoring device according to the first aspect further including a storage (the normal state storage of normal state storage/machine learning model 54) that stores a normal state of the target system, the normal state being a state in which the monitoring target is not under attack. Here, the determiner determines whether the anomaly that occurred in the monitoring target is caused by an attack, by comparing the state obtained with the normal state.

Accordingly, through comparison with the normal state stored in the storage, it is possible to determine whether the cause of the anomaly that occurred in the monitoring target is an attack.

Furthermore, a monitoring device according to a third aspect is the monitoring device according to the first aspect, in which, the determiner determines whether the anomaly that occurred in the monitoring target is caused by an attack, by determining, using a machine learning model (the machine learning model of normal state storage/machine learning model 54), whether the state obtained corresponds to a normal state of the target system, the normal state being a state in which the monitoring target is not under attack, the machine learning model having learned the normal state.

Accordingly, through inference using the machine learning model, it is possible to determine whether the cause of the anomaly that occurred in the monitoring target is an attack.

Furthermore, a monitoring device according to a fourth aspect is the monitoring device according to any one of the first to third aspects, in which, when the monitoring result obtained indicates that an anomaly has occurred in the monitoring target, the determiner determines whether the anomaly that occurred in the monitoring target is caused by an attack, based on the state obtained before the monitoring result is obtained.

Accordingly, when the monitoring result indicates that an anomaly has occurred in the monitoring target, whether or not the anomaly is caused by an attack can be determined according to the state obtained before the monitoring result is obtained.

Furthermore, a monitoring device according to a fifth aspect is the monitoring device according to any one of the first to fourth aspects, in which, the monitoring target includes a process executed on the target system, and the state includes at least one of a utilization rate of a processing resource in the target system, a level of execution privilege for the process executed on the target system, a total number of processes executed on the target system, or a system temperature of the target system.

Accordingly, at least one of the utilization rate of a processing resource in the target system, the level of execution privilege for the process executed on the target system, the total number of processes executed on the target system, or the system temperature of the target system can be obtained as the state and used in determining the cause of the anomaly.

Furthermore, a monitoring device according to a sixth aspect is the monitoring device according to any one of the first to fifth aspects, in which, the determiner calculates, based on the state obtained, a degree of confidence that the anomaly that occurred in the monitoring target is caused by an attack, and outputs the degree of confidence as the determination result.

Accordingly, the degree of confidence (level, score, probability, or the like) that the anomaly that occurred in the monitoring target is caused by an attack can be calculated and outputted as the determination result. For this reason, it is possible to reassess what kind of measures are necessary, and so on, using the degree of confidence indicated by the determination result as a reference. In other words, the monitoring device can output a determination result for assessing what kind of measures are necessary, and so on.

Furthermore, a monitoring device according to a seventh aspect is the monitoring device according to any one of the first to sixth aspects, in which, the anomaly that occurred in the monitoring target includes at least one of: detection of tampering with a memory area used by a process (process executed in application unit 31) executed as the monitoring target; or abnormal termination of the process executed as the monitoring target.

Accordingly, for at least one of a memory area tampering anomaly or an abnormal termination of process anomaly, it is possible to determine whether the anomaly is caused by an attack.

Furthermore, a monitoring method according to an eighth aspect is a monitoring method for monitoring a monitoring target, which is to be executed by a computer. The monitoring method includes: obtaining a monitoring result of monitoring the monitoring target (S10); obtaining a state of a target system in which the monitoring target is provided (S20); and determining, based on the monitoring result obtained and the state obtained, a cause of an anomaly that occurred in the monitoring target (S30, S40), and outputting a determination result indicating whether the anomaly is caused by an attack (S50).

Accordingly, it is possible to produce the same advantageous effects as the above-described monitoring device.

A recording medium according to a ninth aspect is a non-transitory computer-readable recording medium having recorded thereon a program for causing the computer to execute the monitoring method described above.

Accordingly, by causing a computer to execute the above-described monitoring method, it is possible to produce the same advantageous effects as the above-described monitoring device.

### Other Embodiments

The monitoring device and the like according to one or more aspects have been described based on the embodiment. However, the present disclosure is not limited to this embodiment. Various variations conceived by those skilled in the art applied to the present embodiment and combinations of constituent components in different embodiments may be included in the present disclosure without departing the scope of the present disclosure.

For example, in the above-described embodiment, the example in which the monitoring device is provided in the vehicle is described. However, this is not limiting. The monitoring device may be provided in a movable body other than a vehicle, such as a railroad vehicle or an aircraft, an electrical apparatus such as a mobile phone or home appliance, or the like.

Furthermore, the monitoring device in the above-described embodiment may be realized by an ECU that is disposed in the vehicle and controls a resource in a zone where the ECU is disposed (what is called a zone ECU) or may be realized by an integrated ECU. The integrated ECU is a central ECU into which a plurality of ECUs are integrated. The integrated ECU is an ECU into which functions that are conventionally provided in separate ECUs are integrated to solve a problem of a development time or costs that increase with an increase in complexity of onboard systems. The integrated ECU is an ECU for which virtualization technology is used to operate a plurality of virtual computers (virtual machines: VM) in one ECU. The zone ECU is connected to, for example, a piece of equipment provided in the vehicle and controls the connected piece of equipment.

Furthermore, in the above-described embodiment, the example in which the OS is Linux, and the kernel layer and the user layer are provided in the normal world is described. However, the OS may be an OS other than Linux. In this case, the normal world may be provided with an application layer where the app exists and a hardware abstraction layer (HAL) that is arranged between hardware and the application layer.

Moreover, in the above embodiments, the respective elements may be implemented as dedicated hardware or may be realized by executing a software program suited to the respective elements. Alternatively, the respective elements may be implemented by a program executor such as a CPU or a processor reading out and executing the software program recorded on a recording medium such as a hard disk or a semiconductor memory.

Also, the processing order of executing the steps shown in the flowcharts is a mere illustration for specifically describing the present disclosure, and thus may be an order other than the shown order. Also, one or more of the steps may be executed simultaneously (in parallel) with another step, and one or more of the above steps need not be executed.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Furthermore, the monitoring device according to the above embodiments may be implemented as a single device or may be implemented as a plurality of devices. When the monitoring device is implemented as a plurality of devices, the respective elements included in the monitoring device may be allocated to the plurality of devices in any manner. When the monitoring device is implemented as a plurality of devices, the communication method between the plurality of devices is not particularly limited, and may be by wireless communication or wired communication. Furthermore, wireless communication and wired communication may be combined between the devices.

Furthermore, each of the elements described in the above embodiments may be implemented as software, and may be implemented typically as a large-scale integration (LSI), which is an integrated circuit (IC). They may take the form of individual chips, or one or more or all of them may be encapsulated into a single chip. Although referred to as LSI here, the integrated circuit may be referred to as an IC, a system LSI, a super LSI, or an ultra LSI depending on the scale of integration. Moreover, the method of implementation of the elements using an integrated circuit is not limited to application of an LSI. The elements may be implemented by a dedicated circuit (a general-purpose circuit that executes a dedicated program) or a general-purpose processor. It is also possible to use a field programmable gate array (FPGA) that can be programmed after the LSI is manufactured, or a reconfigurable processor in which connection and setting of circuit cells in the LSI can be reconfigured.

The system LSI is a super multifunctional LSI manufactured by integrating a plurality of processing units onto a single chip. Specifically, the system LSI is a computer system configured with a microprocessor, a ROM, and so on. The ROM stores a computer program. The microprocessor operates according to the computer program, so that a function of the system LSI is achieved.

Furthermore, an aspect of the present disclosure may by a computer program for causing a computer to execute each of the characteristic steps included in the monitoring method illustrated in any one of FIG. 3 and FIG. 4.

Furthermore, an aspect of the present disclosure may be a non-transitory computer-readable recording medium having such a program recorded thereon. For example, such a program may be distributed or circulated by being recorded on the recording medium. For example, by installing the distributed program in a device including another processor and causing the processor to execute the program, it is possible to cause the device to execute the respective processes described above.

### Further Information about Technical Background to this Application

The disclosure of the following patent application including specification, drawings, and claims is incorporated herein by reference in its entirety: Japanese Patent Application No. 2025-055440 filed on March 28, 2025.

### Industrial Applicability

The present application is useful to a monitoring device, or the like, which monitors a monitoring target such as an application.

1. A monitoring device that monitors a monitoring target, the monitoring device comprising:
a first obtainer that obtains a monitoring result of monitoring the monitoring target;
a second obtainer that obtains a state of a target system in which the monitoring target is provided; and
a determiner that determines, based on the monitoring result obtained and the state obtained, a cause of an anomaly that occurred in the monitoring target, and outputs a determination result indicating whether the anomaly is caused by an attack.

2. The monitoring device according to claim 1, further comprising:
a storage that stores a normal state of the target system, the normal state being a state in which the monitoring target is not under attack, wherein
the determiner determines whether the anomaly that occurred in the monitoring target is caused by an attack, by comparing the state obtained with the normal state.

3. The monitoring device according to claim 1, wherein
the determiner determines whether the anomaly that occurred in the monitoring target is caused by an attack, by determining, using a machine learning model, whether the state obtained corresponds to a normal state of the target system, the normal state being a state in which the monitoring target is not under attack, the machine learning model having learned the normal state.

4. The monitoring device according to claim 1, wherein
when the monitoring result obtained indicates that an anomaly has occurred in the monitoring target, the determiner determines whether the anomaly that occurred in the monitoring target is caused by an attack, based on the state obtained before the monitoring result is obtained.

5. The monitoring device according to claim 1, wherein
the monitoring target includes a process executed on the target system, and
the state includes at least one of a utilization rate of a processing resource in the target system, a level of execution privilege for the process executed on the target system, a total number of processes executed on the target system, or a system temperature of the target system.

6. The monitoring device according to claim 1, wherein
the determiner calculates, based on the state obtained, a degree of confidence that the anomaly that occurred in the monitoring target is caused by an attack, and outputs the degree of confidence as the determination result.

7. The monitoring device according to claim 1, wherein
the anomaly that occurred in the monitoring target includes at least one of: detection of tampering with a memory area used by a process executed as the monitoring target; or abnormal termination of the process executed as the monitoring target.

8. A monitoring method for monitoring a monitoring target, which is to be executed by a computer, the monitoring method comprising:
obtaining a monitoring result of monitoring the monitoring target;
obtaining a state of a target system in which the monitoring target is provided; and
determining, based on the monitoring result obtained and the state obtained, a cause of an anomaly that occurred in the monitoring target, and outputting a determination result indicating whether the anomaly is caused by an attack.

9. A non-transitory computer-readable recording medium having recorded thereon a program for causing the computer to execute the monitoring method according to claim 8.
